(19) United States
(12) Patent Application Publication
(10) Pub. No.: US 2012/0234250 A1
(43) Pub. Date: Sep. 20, 2012

(54) COLLAPSIBLE KENNEL FEEDER

(76) Inventors: Ellis N. Shamoon, Dallas, TX (US); John Hollingsworth, Dallas, TX (US); Thomas Murphy, Arlington, TX (US)

(21) Appl. No.: 13/422,944

(22) Filed: Mar. 16, 2012

Related U.S. Application Data
(63) Continuation-in-part of application No. 29/387,706, filed on Mar. 17, 2011.

(51) Int. Cl. A01K 5/00

(52) U.S. Cl. 119/61.57

(57) ABSTRACT

A collapsible feeder is provided for use in combination with a cage or kennel. The feeder includes a collapsible container and a cage-mounted hinge. The collapsible container is made from a flexible material that collapses to a flat profile, and the collapsible container is connected to the cage-mounted hinge so that the collapsible container and adjacent apparatus may be folded up against the cage to maximize interior cage space when not in use.

### CROSS-REFERENCE TO RELATED APPLICATION

This is a continuation-in-part application based on U.S. patent application Ser. No. 29/387,706 filed on Mar. 17,2011.

### FIELD OF THE INVENTION

The present invention relates to kennel cage feeders. More particularly, the invention is a kennel cage feeder with a collapsible container made from a flexible material that collapses to a relatively flat profile, with the collapsible container connected to a cage-mounted hinge so that the collapsible container may be folded against the cage to maximize interior cage space when not in use.

### BACKGROUND OF THE INVENTION

Cage-mounted feed dishes are well known and available in a variety of different configurations and sizes. Known cage-mounted feed dishes utilize a variety of different methods for attachment to a side of a cage, and in some cases provide a means for altering the position of the dish for pets of different sizes. Such devices are often designed to be removable by the owner so that pets will have more space when the device is not in use.

U.S. Pat. No. 7,513,219 discloses an easy to remove mounting system that can accommodate various cage wall thicknesses.

U.S. Pat. No. 6,928,953 discloses a feeder which can be adjusted for positioning at a selected location in the interior space of a cage.

The prior art, however, does not provide a convenient means for repositioning a feed dish for storage without removal of the feeder device. There is a need then for a collapsible feed dish that can be easily transitioned between use and storage configurations without removal of the device itself.

### SUMMARY OF THE INVENTION

The present invention provides a solution to this problem by allowing a feeder to transition from a feed-bowl configuration to a storage configuration where it is folded against a cage wall. The collapsible container is preferably made from a flexible membrane material such as TPE or silicone, so that the feeder container can be collapsed to a thin profile. The user can easily collapse the dish from an open-topped container to a relatively flat storage configuration by manually compressing the membrane. A hinge mechanism attached to the feed dish allows the flattened feed dish to be easily folded up against a side of the cage by the user, giving the pet more space in the cage without the need for removing the entire device.

Though it is intended to fully describe the invention as set forth here, it is reasonable to assume that one skilled in the art could adjust, modify, subtract or adapt certain aspects of this collapsible kennel feeder without departing from its original scope. Individual or combined improvements disclosed here could be implemented as part of another collapsible kennel feeder. For example, adding another type of collapsible container device would be well within the bounds of what has been revealed herein. Another example would be to utilize a different means for folding the collapsed feeder against the side of the cage. Still another example would be to mount or suspend a collapsible feeder from the cage floor or ceiling.

The gist of this collapsible kennel feeder is that, in addition to being easily reconfigured to save space, it also does not require removal. The recommended materials will likely be, but are not limited to, rigid and elastomeric plastics.

### BRIEF DESCRIPTION OF THE DRAWINGS

A more complete understanding of the invention and its advantages will be apparent from a review of the Detailed Description in conjunction with the following Drawings, in which:

FIG. 1 is a top perspective view of a Collapsible Kennel Feeder showing the cage-mounted screw lock, hinge mechanism, and collapsible membrane in the use configuration.

FIG. 2 is a top view of the Collapsible Kennel Feeder of FIG. 1 in the use configuration.

FIG. 3 is a bottom view of the Collapsible Kennel Feeder of FIG. 1 in the use configuration.

FIG. 4 is a front view of the Collapsible Kennel Feeder of FIG. 1 in the use configuration.

FIG. 5 is right-side view of the Collapsible Kennel Feeder of FIG. 1 in the use configuration.

FIG. 6 is rear view of the Collapsible Kennel Feeder of FIG. 1 in the use configuration.

FIG. 7 is a right-side view of the Collapsible Kennel Feeder of FIG. 1 in the storage configuration.

### DETAILED DESCRIPTION

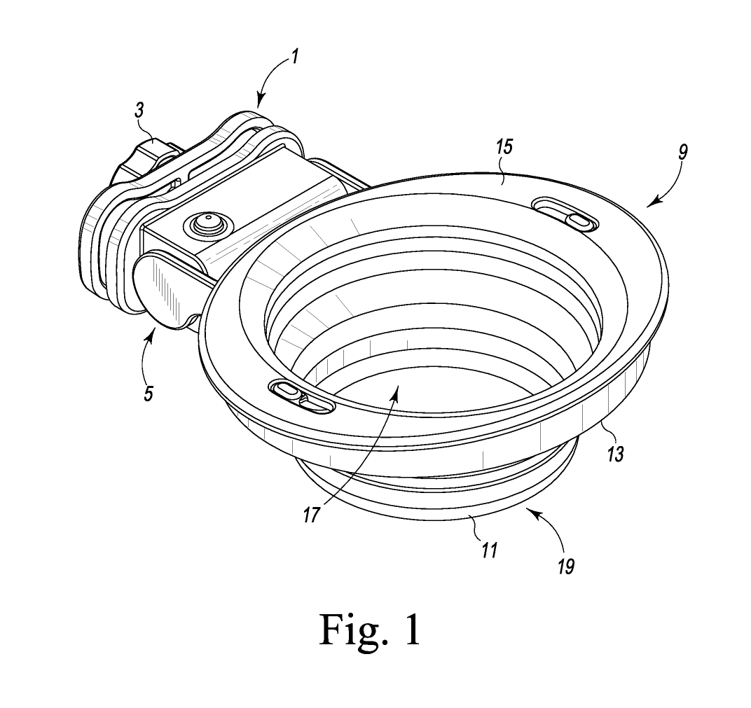

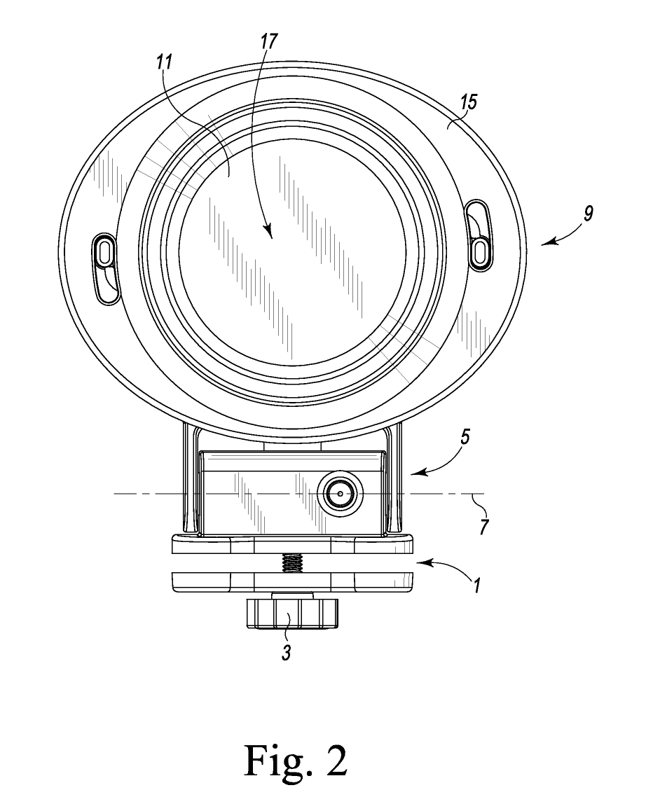

Referring initially to FIGS. 1-7, where like numerals indicate like and corresponding elements, the user fastens the mounting structure 1 to the side of a cage or kennel (not shown) by means of an adjustable screw clamp 3. The mounting structure 1 is coupled to a hinge 5 which allows at least 60-degree, and preferably 90-degree, movement along an axis 7 relative to a collapsible container 9 attached to the opposite side of the hinge 5. The collapsible container 9 includes a collapsible membrane 11, preferably made from a flexible elastomeric material such as a thermoplastic elastomer (TPE) or silicone. Collapsible membrane 11 is supported by a rigid support frame 13 about the perimeter 15 of the collapsible container 9. Support frame 13 is preferably made from a hard plastic such as polypropylene.

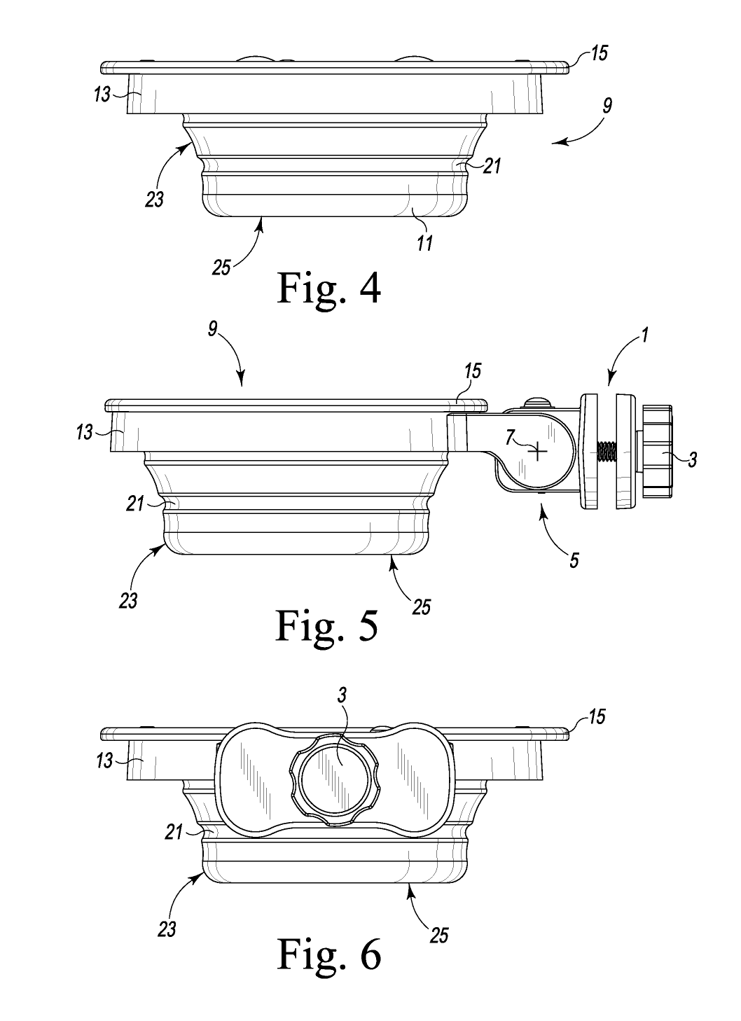

In the use configuration (FIGS. 1-6), the hinge 5 has been actuated by the user so that the perimeter 15 of the collapsible container 9 is roughly parallel to the floor of the cage or kennel. The collapsible container 9 has been expanded by applying pressure to the top planar surface 17 of the collapsible container 9 to form an open-topped container 19 (FIG. 1) defined by the placement of membrane hinges 21 (FIG. 4-6) along the outer perimeter 23 of the membrane 11 (FIG. 4-6). Food or water may then be placed within the open-topped container 19.

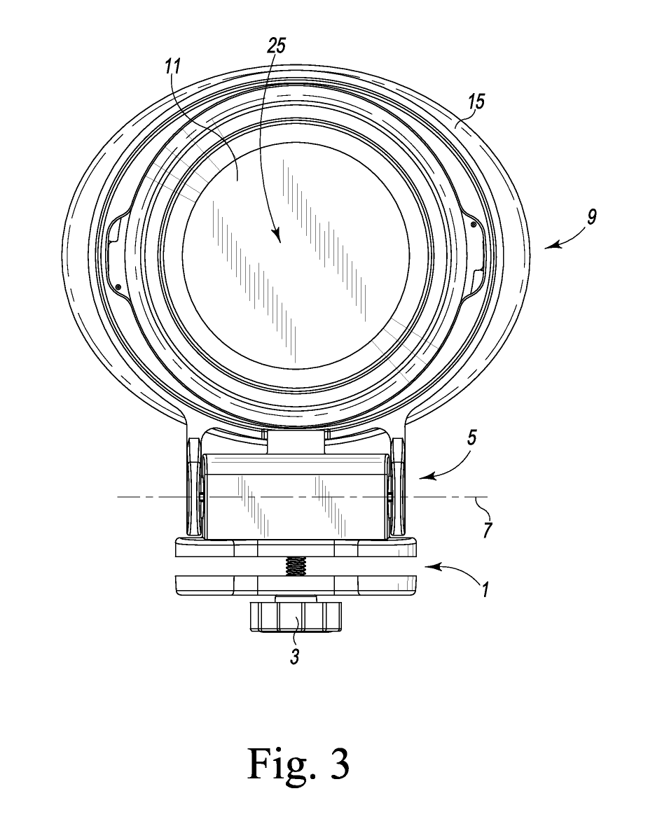

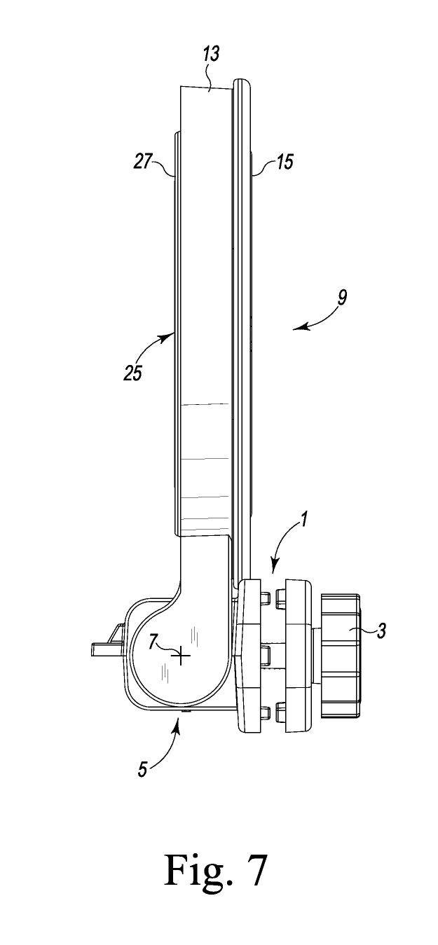

In the storage configuration (FIG. 7) the hinge 5 has been actuated by the user so that the perimeter 15 of the collapsible container 9 is at least 60-degrees closer to, and preferably completely, parallel to the cage or kennel surface to which the mounting structure 1 is mounted. The collapsible container 9 has been collapsed by applying pressure to the bottom planar surface 25 of the collapsible membrane 11 (FIG. 3-7) to form a collapsed container 27 (FIG. 7). The amount of space within the cage/kennel is thus substantially increased in the storage configuration, allowing a pet to roam more freely when the device is in the storage configuration.

While the invention has been illustrated and described as embodied one type of collapsible kennel feeder, it is not intended to be limited to the details shown, since it will be understood that various omissions, modifications, substitutions and changes in the forms and details of the device illustrated in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A collapsible kennel feeder, comprising:
a mounting structure for attaching the collapsible kennel feeder to a cage or kennel;
a collapsible container; and
a hinge coupled to the mounting structure and the collapsible container, wherein the hinge allows for repositioning of the collapsible container relative to the mounting structure along at least one axis.

2. The collapsible kennel feeder of claim 1, where the mounting structure includes a screw clamp.

3. The collapsible kennel feeder of claim 1, where the collapsible container includes a flexible elastomeric membrane.

4. The collapsible kennel feeder of claim 3, where the membrane is connected to a rigid support frame about the perimeter of the membrane.

5. The collapsible kennel feeder of claim 1, where the collapsible container has at least two selectable configurations.

6. The collapsible kennel feeder of claim 5, where the two selectable configurations are a use configuration, wherein the collapsible container forms an open-topped container, and a storage configuration, wherein the collapsible container is collapsed and has a reduced volume profile.

7. The collapsible kennel feeder of claim 1, where the collapsible container can be repositioned at least 60-degrees along at least one axis relative to the mounting structure.

8. The collapsible kennel feeder of claim 5, where the collapsible container is comprised of a flexible elastomeric membrane.

9. The collapsible kennel feeder of claim 5, where the mounting structure is comprised of a screw clamp.

10. The collapsible kennel feeder of claim 8, where the membrane is connected to a rigid support frame about a perimeter of the membrane.

11. The collapsible kennel feeder of claim 5, where the two selectable configurations are a use configuration, wherein the collapsible container forms an open-topped container, and a storage configuration, wherein the collapsible container is collapsed and has a reduced volume profile.

12. The collapsible kennel feeder of claim 5, where the collapsible container can be repositioned at least 60-degrees along at least one axis relative to the mounting structure.

13. A collapsible kennel feeder, comprising:
a mounting structure for attaching the collapsible kennel feeder to a cage or kennel;
a collapsible container including a flexible elastomeric membrane, and where the collapsible container has at least two selectable configurations, the two selectable configurations being a use configuration, wherein the membrane forms an open-topped container, and a storage configuration, wherein the membrane is collapsed and has a reduced volume profile; and
a hinge coupled to the mounting structure and the collapsible container, wherein the hinge allows for repositioning of the collapsible container relative to the mounting structure along at least one axis.

14. The collapsible kennel feeder of claim 13, where the mounting structure includes a screw clamp.

15. The collapsible kennel feeder of claim 13, where the membrane is connected to a rigid support frame about a perimeter of the membrane.

16. The collapsible kennel feeder of claim 13, where the collapsible container can be repositioned at least 60-degrees along at least one axis relative to the mounting structure.

17. A collapsible kennel feeder, comprising:
a mounting structure for attaching the collapsible kennel feeder to the cage or kennel, wherein the mounting structure includes a screw clamp;
a collapsible container including a flexible elastomeric membrane, with the membrane being connected to a rigid support frame about a perimeter of the membrane, where the collapsible container has at least two selectable configurations, and where the two selectable configurations are a use configuration, wherein the membrane forms an open-topped container, and a storage configuration, wherein the collapsible container is collapsed and has a reduced volume profile; and
a hinge coupled to the mounting structure and the collapsible container, wherein the hinge allows for repositioning of the collapsible container relative to the mounting structure, and wherein the collapsible container can be repositioned at least 60-degrees along an axis relative to the mounting structure.
